(19) United States
(12) Patent Application Publication
(10) Pub. No.: US 2008/0221979 A1
(43) Pub. Date: Sep. 11, 2008

(54) System and Method for Generating, Producing, and Distributing Advertising Materials

(76) Inventor: Harry Engel, Palmdale, CA (US)

Correspondence Address: WHITE-WELKER & WELKER, LLC, P.O. BOX 199, CLEAR SPRING, MD, 21722-0199, US

(21) Appl. No.: 11/683,307

(22) Filed: Mar. 7, 2007

(51) Int. Cl. G06Q 30/00

(52) U.S. Cl. 705/14

(57) ABSTRACT

The present invention is a method for generating, producing, and distributing advertising materials. The present invention utilizes an Internet web site that allows a user to upload a testimonial and then use the testimonial in combination with pre-designed templates to generate posters, brochures, websites, and other advertising articles. The present invention utilizes an Internet web site that allows a user to upload his businesses information such as logos, address, names, and telephone numbers once and then uploads testimonials and then use the testimonials in combination with pre-designed templates to generate posters, brochures, magazines, flyers, email, websites, video and other advertising articles.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to a method for creating advertisements and marketing materials. More specifically, the present invention relates to an Internet web site that allows a user to upload a testimonial and then use the testimonial in combination with pre-designed templates that merge in the users information, logos, etc. to generate posters, brochures, websites, and other advertising articles.

### BACKGROUND OF THE INVENTION

New customers, clients or in the case of doctors offices, patients are most often created by either advertising or referrals. What is needed is a method which creates low cost advertising campaigns and increases referrals from existing customers by providing a simple software solution for the generation of advertising materials that utilizes a company's existing customer base and contacts to generate the advertising content and provide a mechanize for internal referral generation of new business or sales.

U.S. Pat. No. 6,084,581 issued to Hunt discloses a system for simultaneously creating a plurality of individually customized video product from a plurality of video segments uses a central computer and one or more workstations to control the operation of a video file server and video recorders connected thereto. An operator at the workstation enters selection choices into a workstation. The central computer uses the selection choices to select and order a subset of video segments prestored on the video file server. Under control of the central computer, the selected and ordered subset of video segments are output from the video file server to a designated video recorder to make the customized video product. Hunt requires a skilled graphical artist or computer operator to generate the customized video content, which is not supportive of a cost effective option for the majority of business to quickly generate their own custom advertising materials.

U.S. Pat. No. 7,064,857 issues to Parker, et al. teaches a method for advertising, comprising the steps of generating a high-quality image; placing one or more advertising data in a predetermined location of the high-quality image; and fixing the high-quality image and advertising data to a utilitarian object. The advertising data is thereby placed in the high-quality image on an object therein so that the advertising data appears to be part of the particular object in the high-quality image. Parker, et al. fails to incorporate or utilize information for an existing customer database or teach the creation of a testimonial based marketing product.

Another shortcoming of the methods taught in the prior art is that they fail to disclose a method that places an existing buyer, client, or patient base into a continuous referral network that repeatedly expands and generates new referrals.

Still another shortcoming of the prior art advertising methods it they fail to use current contacts and customer base to generate internal referrals from contacts and existing buyers, clients, or patients by enabling the creating of custom posters, brochures, mailers and magazines featuring personal logos and third party testimonials, with a minimal amount of keystrokes using computer software.

Yet another shortcoming is that the prior art does not disclose a low cost advertising generation, production, and distribution system or method that is simple to use and requires no graphics skills.

### SUMMARY OF THE INVENTION

The present invention is a method for generating, producing, and distributing advertising materials. The present invention utilizes an Internet web site that allows a user to upload his businesses information such as logos, address, names, and telephone numbers once and then upload testimonials and then use the testimonials in combination with pre-designed templates to generate posters, brochures, magazines, flyers, email, websites, video and other advertising articles.

It is an objective of the present invention to teach a method for low cost advertising generation, production, and distribution that is simple to use and requires no graphics skills.

In addition, it is the objective to increases internal referrals from contacts and existing buyers, clients, or patients by enabling the creating of custom posters, brochures, mailers and magazines featuring personal logos and third party testimonials, with a minimal amount of keystrokes using computer software.

It is another objective to teach a method of advertising that transforms an existing buyer, client, or patient base into a continuous referral network that repeatedly expands and generates new referrals.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a screen shot of the GUI of the present invention;

FIG. 2 is a screen shot of the clinic management section and existing clinics list of a representative embodiment of the present invention;

FIG. 3 is a screen shot of the clinic management section and an all user list of an embodiment of the present invention;

FIG. 4 is a screen shot of the user management section and detailed user information database of a representative embodiment of the present invention;

FIG. 5 is a screen shot of the template management section and template style list of a representative embodiment of the present invention;

FIG. 6 is a screen shot of the template management section and complete template list of a representative embodiment of the present invention;

FIG. 7 is a screen shot of the testimonial management section and testimonial detail database view of a representative embodiment of the present invention;

FIG. 8 is a screen shot of the image library GUI of the present invention;

FIGS. 9-10 are screen shots of the shop settings and product forms and information of a representative embodiment of the present invention;

FIG. 11 is a screen shot of the shop settings and product category list of a representative embodiment of the present invention;

FIG. 12 is a screen shot of the administration control and record list of a representative embodiment of the present invention;

FIG. 13 is a screen shot of the administration control and project list of a representative embodiment of the present invention;

FIG. 14 is a screen shot of the administration control and reporting feature of a representative embodiment of the present invention; and

FIG. 15 is a flow chart illustrating the steps of the method of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is a method for generating, producing, and distributing advertising materials. The present invention utilizes an Internet web site that allows a user to upload a testimonial and then use the testimonial in combination with pre-designed templates to generate posters, brochures, websites, and other advertising articles.

In a best mode embodiment, the present invention is used to assist medical professionals and medical specialists in the development of your practice. The samples illustrated in the Figures illustrate the use of the system and method taught by the present invention for use by healthcare providers such as doctors' offices, drug manufacturers, dentists, chiropractors, physicians, rehabilitations providers, or medical clinics, but the invention is not limited to this usage. For example, the method is applicable to all service professions or products that provide a benefit.

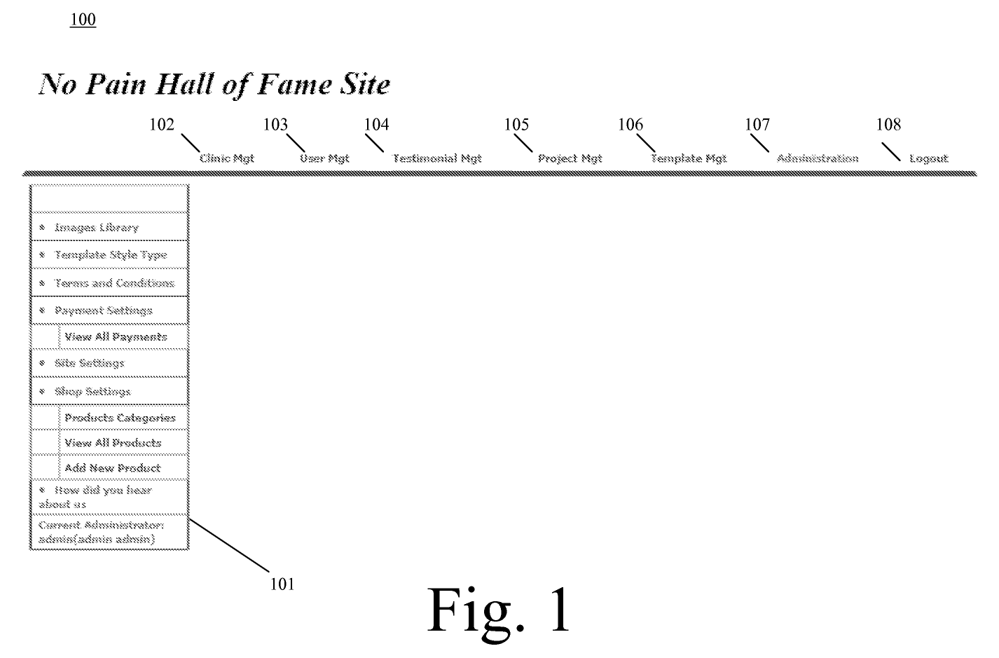

Now referring to FIG. 1, a screen shot of the GUI 100 of the present invention is shown. The system of the present invention consists of a clinic or business management component 102, a user management component 103, a testimonial management component 104, a project management component 105, a template management component 106, and an administrative management component 107. To navigate the website, links are provide for each component and a control panel 101 also allows for the selection of components and sub-components.

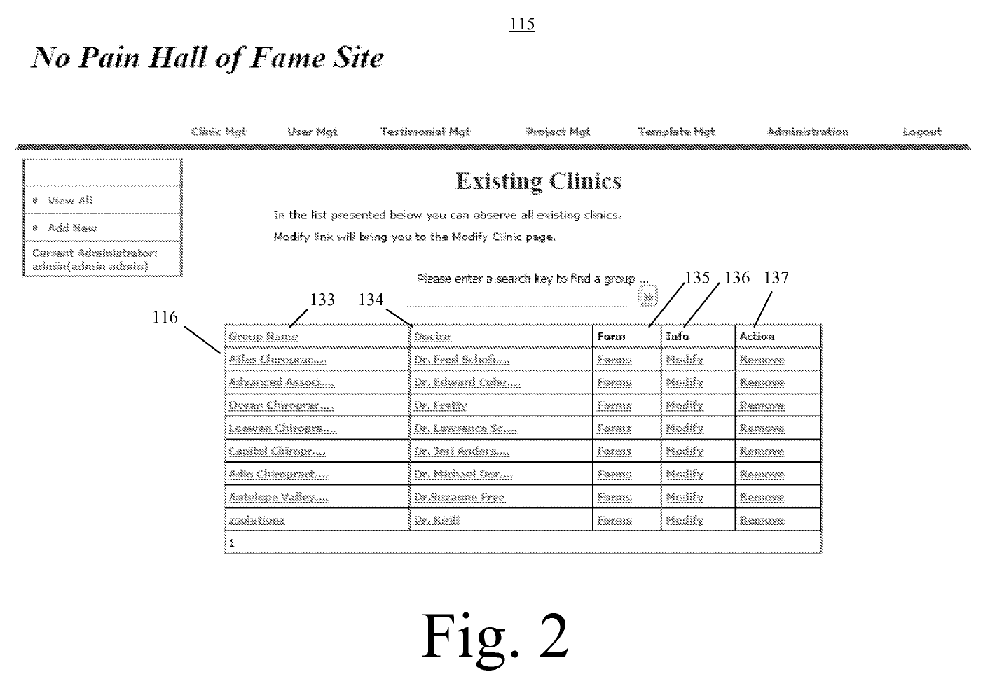

FIG. 2 is a screen shot of the clinic or business management section 115 and existing clinics list 116 of the present invention. The existing client list 116 includes group or business name 133, healthcare provider information, business owner information 134, forms 135, information 136, and an action link 137. Additionally, a logo may be uploaded and edited with provided graphical tools.

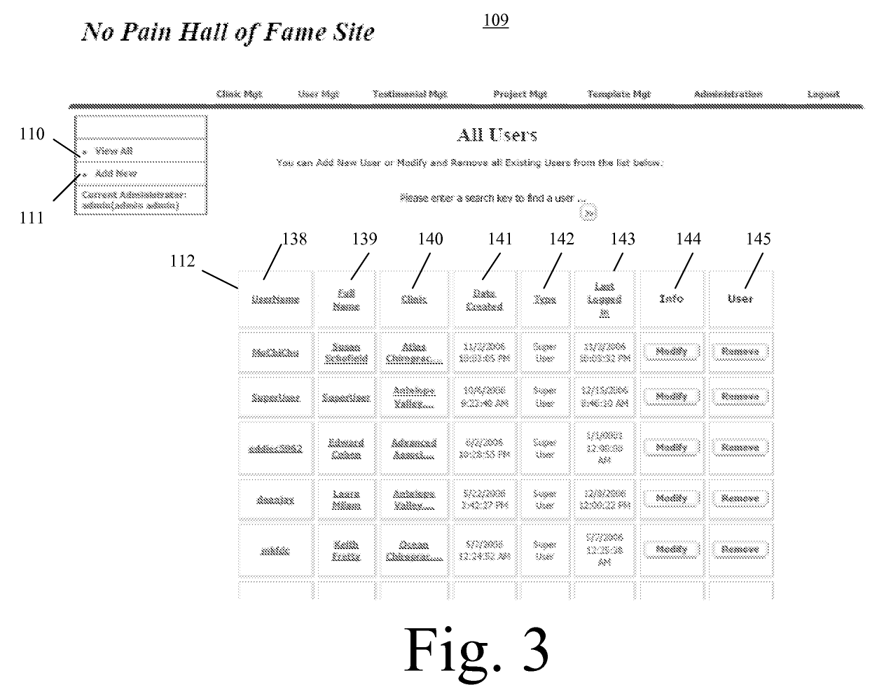

Now referring to FIG. 3, a screen shot of the clinic management section 109 and an all user list 112 of the present invention is shown. Each user provides a username 138, full name 139, clinic name 140, and additional information 144. The system tracks the user's creation date 141, assigns a user class or type 142, records activity and log information 143, and allows for removal 145. Additionally, the control panel provides a view all 110 selections and add a new user feature 111.

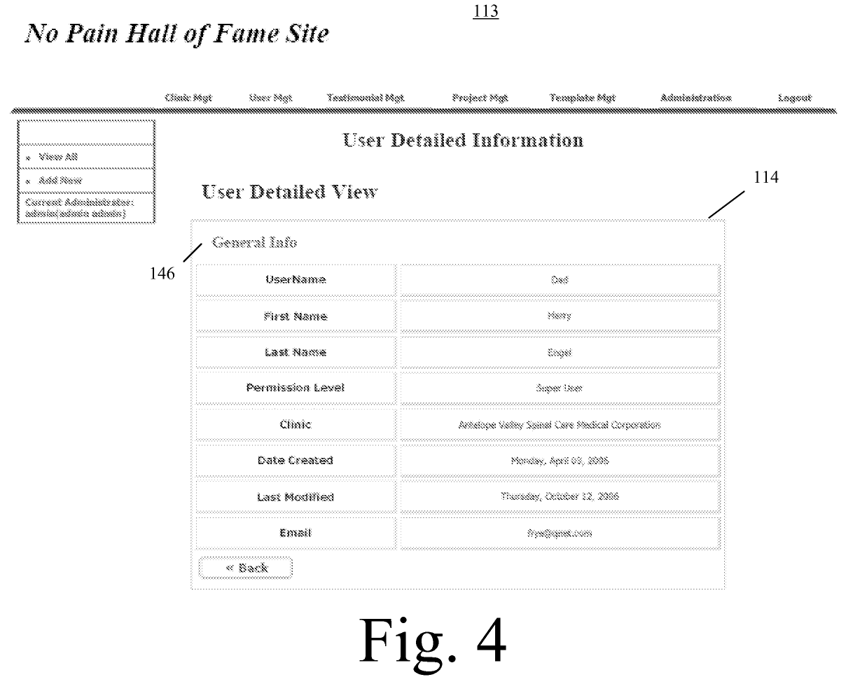

FIG. 4 is a screen shot of the user management section and detailed user information database 113 of the present invention. The user detailed view 114 contains general information 146 uploaded or added by the user to the system.

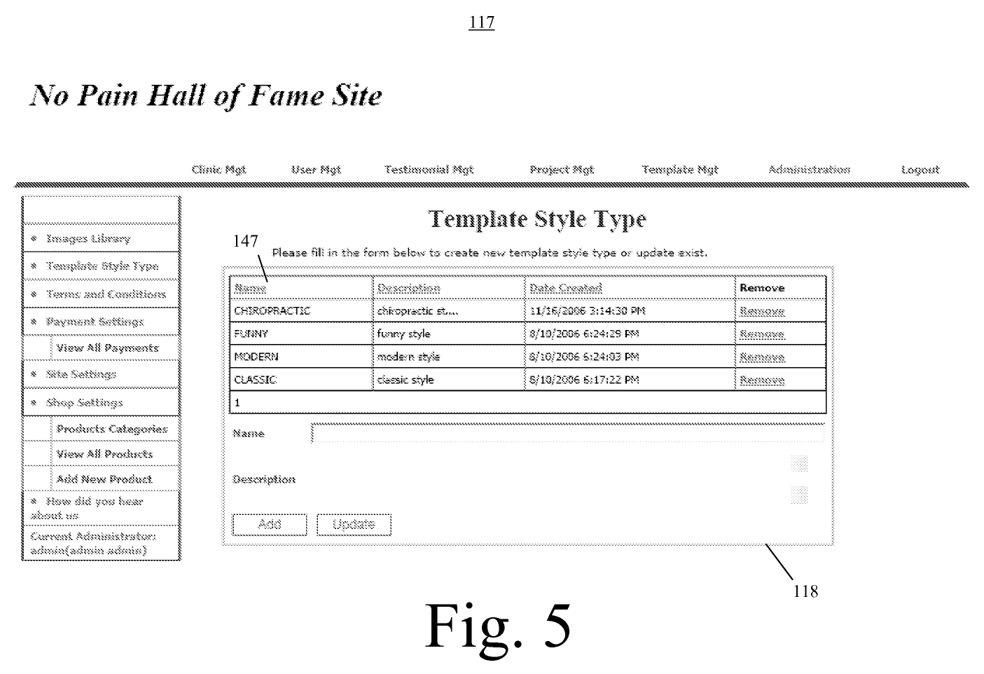

Now referring to FIG. 5, a screen shot of the template management section and template style list 117 of the present invention is shown. The template style type 118 contains name, description and other information 147 for each template available to a user.

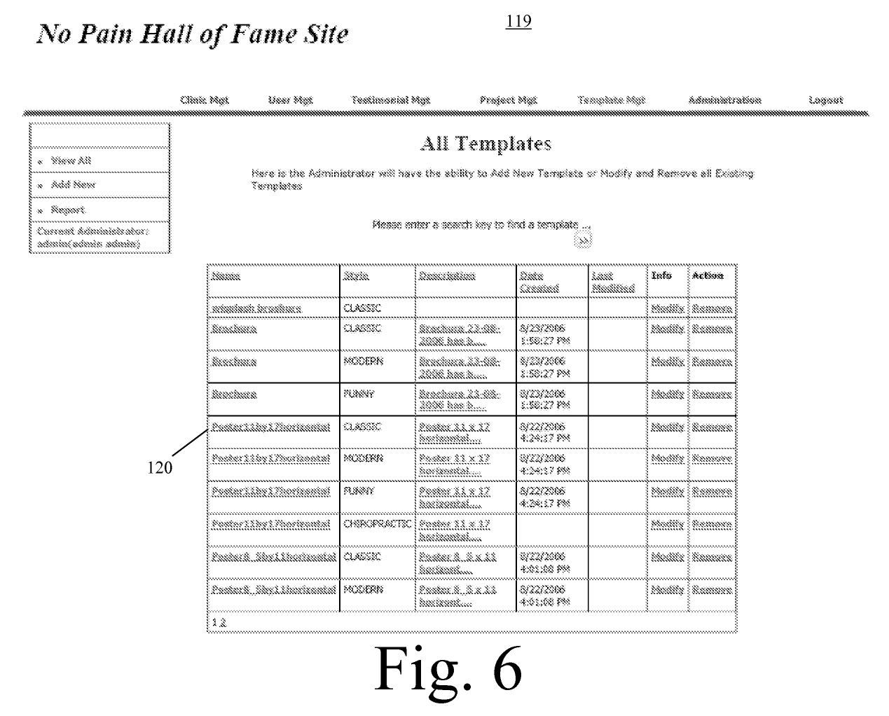

FIG. 6 is a screen shot of the template management section 119 and complete template list 120 of the present invention and displays all templates for use by a user and provides the ability of an administrator to add new template, modify existing templates or remove templates.

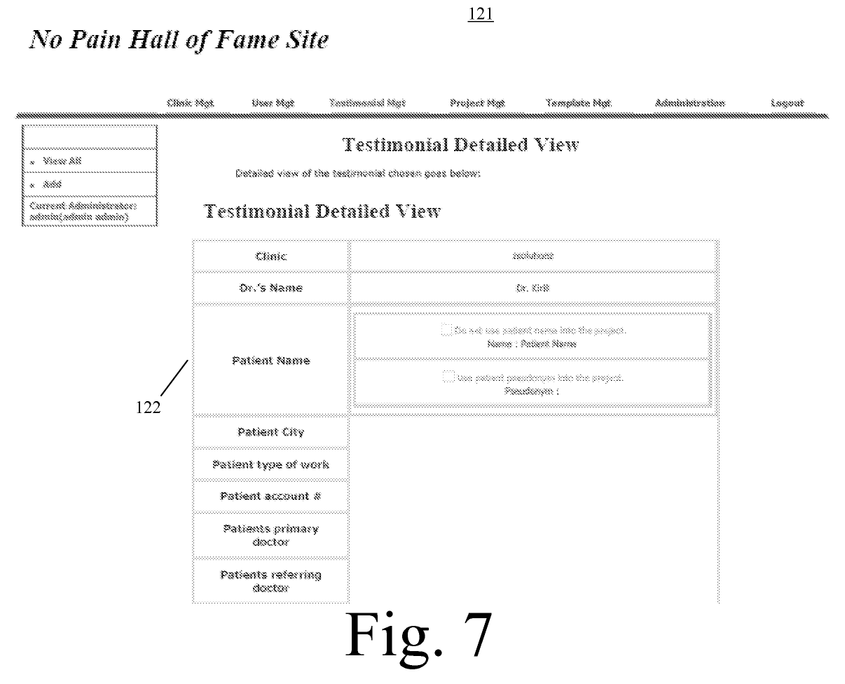

Now referring to FIG. 7, a screen shot of the testimonial management section 121 and testimonial detail database view 122 of the present invention is shown. Testimonial detail as structured for healthcare providers can include the clinic name, healthcare provider's name, patient name, city, account number, primary healthcare provider, referring healthcare provider, and services performed. In addition details about the patients condition can be entered into the database. If this were a different business, testimonial detail relevant to that business model would be recorded appropriately.

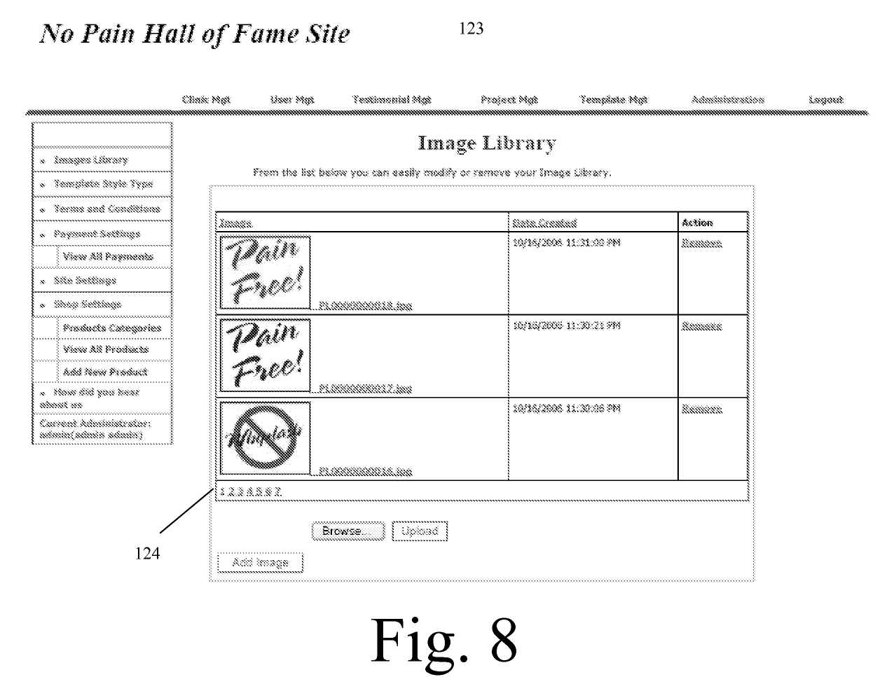

FIG. 8 is a screen shot of the image library GUI 123 of the present invention that provides a database of images 124 for use in templates that may be searched and selected during the advertising generation process. These images are used in addition to, or to replace photographs of the person providing the testimonial

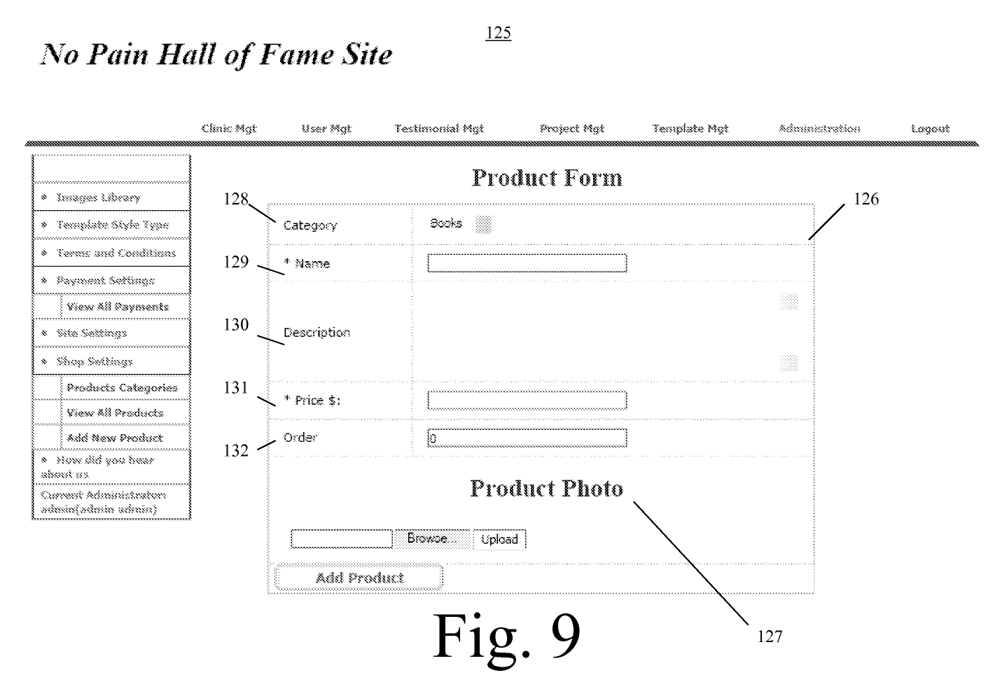

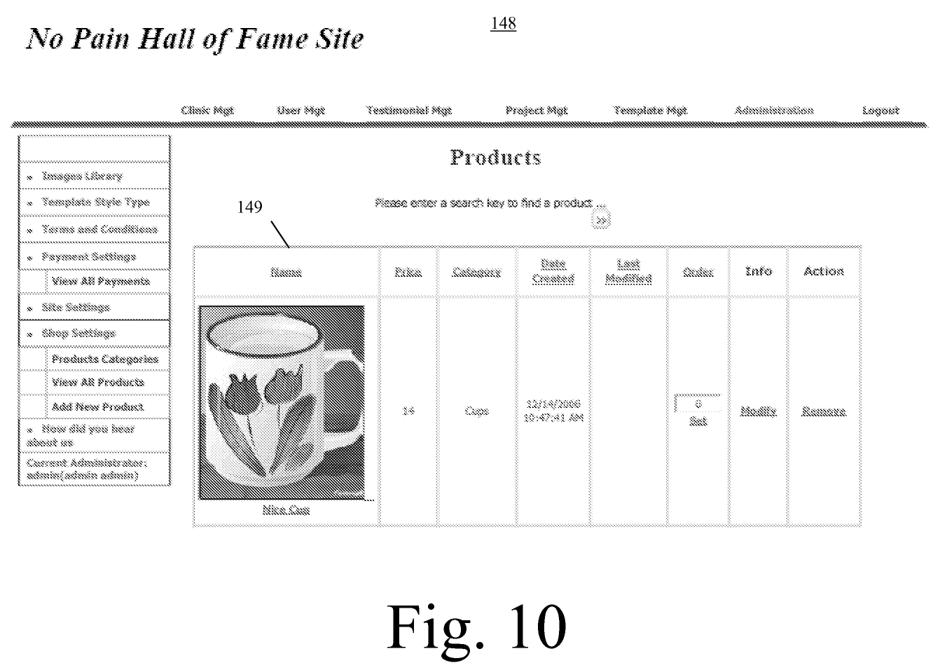

FIGS. 9-10 are screen shots of the shop settings and product forms 125 and information 148 of the present invention. These allow for the creation of specialized marketing materials utilizing the method of this invention. The product form 126 contains category 128, name 129, description 130, price, order 137, and photo information 127 for each product in the shopping database. The shopping component of the present invention functions like those taught in the prior art where each product 149 is viewable and can be added to a shopping cart for processing.

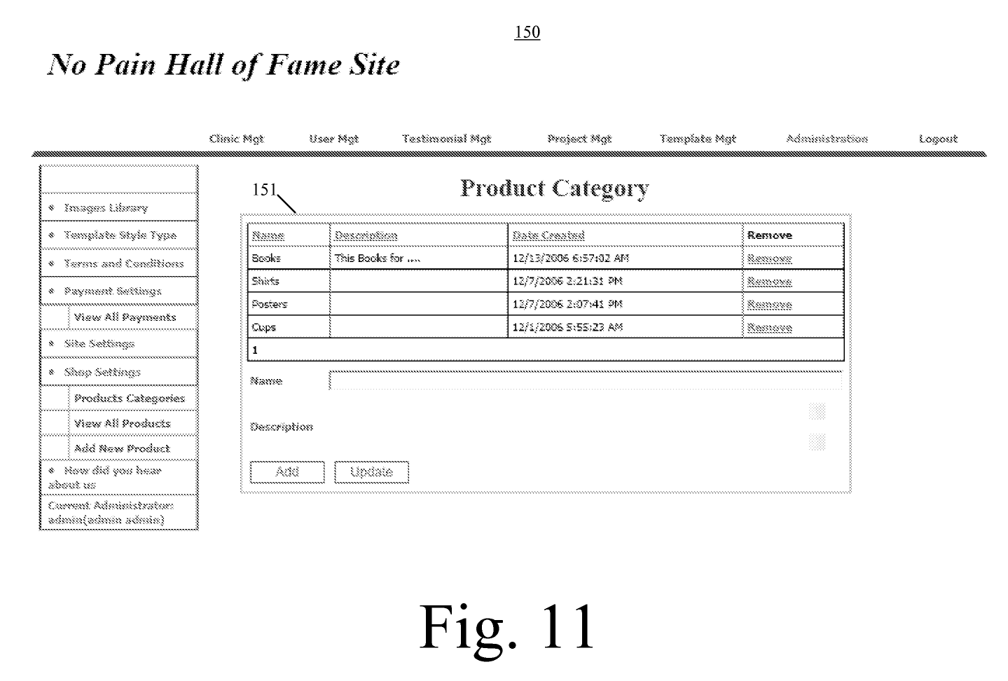

FIG. 11 is a screen shot of the shop settings and product category list 150 of the present invention and illustrates the product categories 151 available.

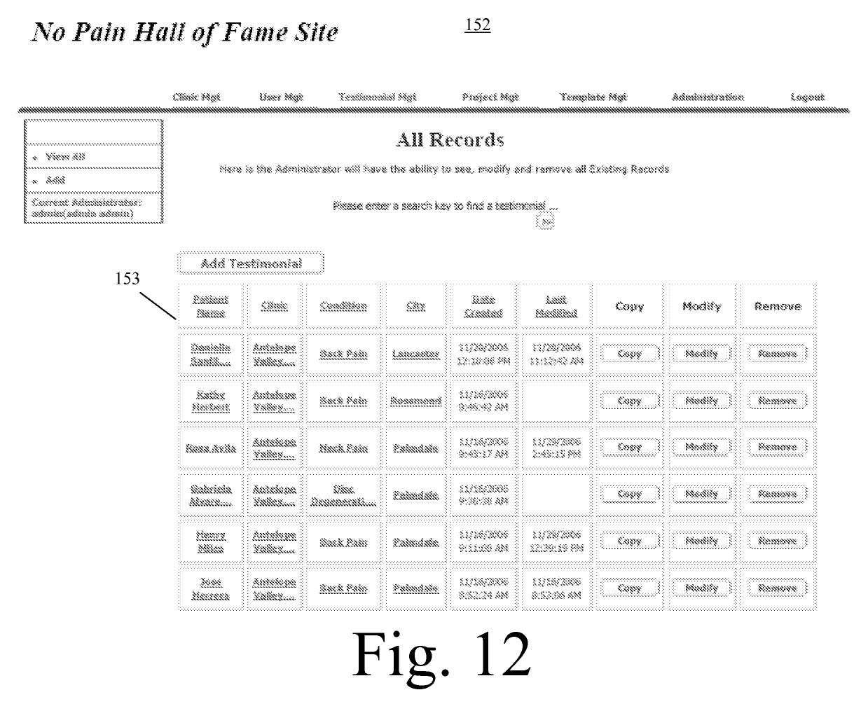

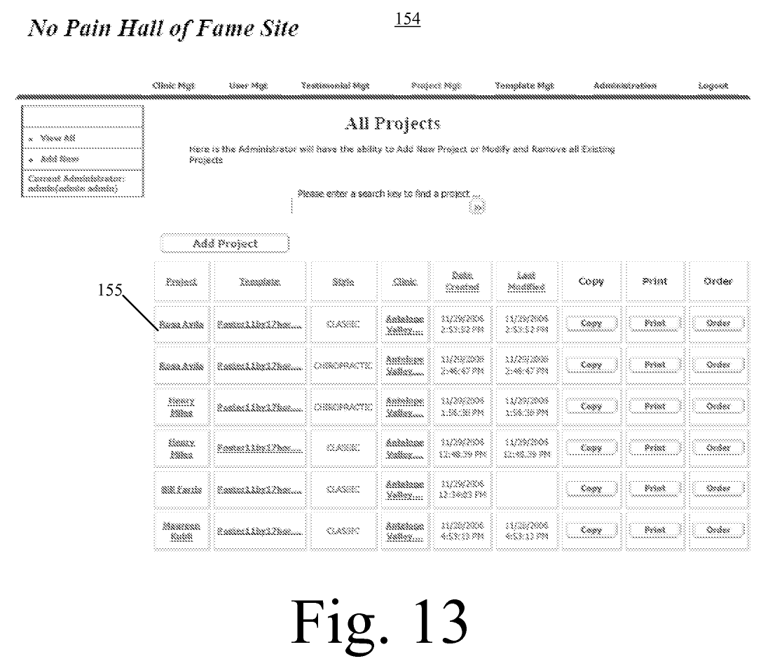

FIGS. 12-14 are screen shots of the administration control panels. FIG. 12 is a screen shot of the administration control and record list 152 of the present invention and illustrates a listing of all records 153 in the database by clinic, patient name, condition, and location for modification or use. FIG. 13 is a screen shot of the administration control and project list 154 of the present invention and illustrates a listing of all projects 155 in the database by project name, template, style, and clinic name for modification or use.

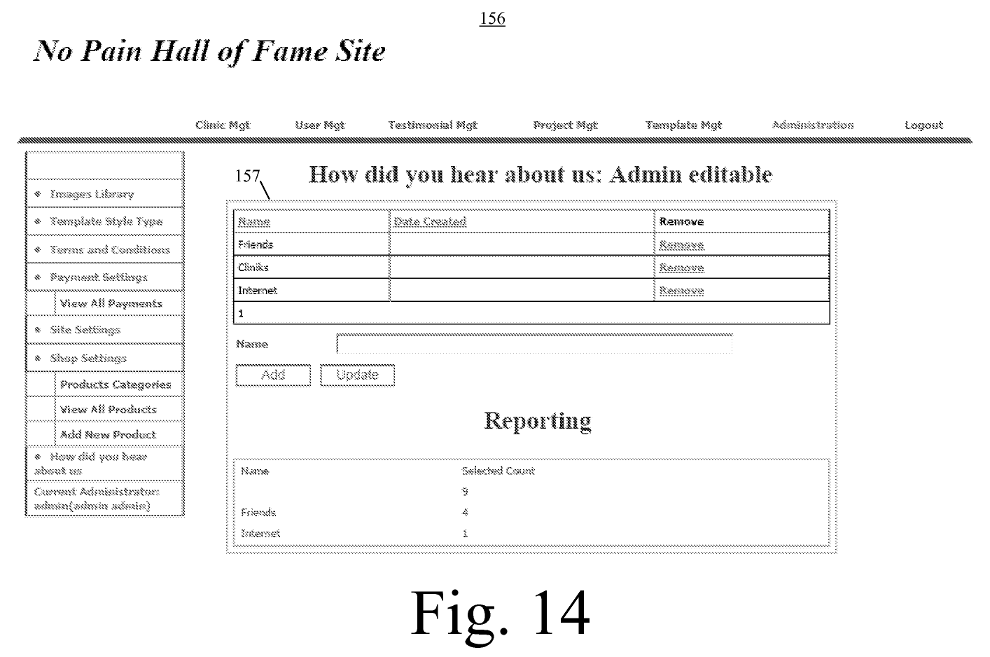

Now referring to FIG. 14, a screen shot of the administration control and reporting feature 156 of the present invention illustrates a feedback or information gathering input screen 157 for use by the administration. The system provides the ability to email, fax, or print a letter, testimonial, or case study that may be sent to a list or selected group or individual user. Lists of referring healthcare providers are also maintained by the systems as well as a list of individuals that the system can be market to in the future. Finally the system provides the ability to select testimonials, healthcare providers, and groups or individual users based upon condition, interest or other factors.

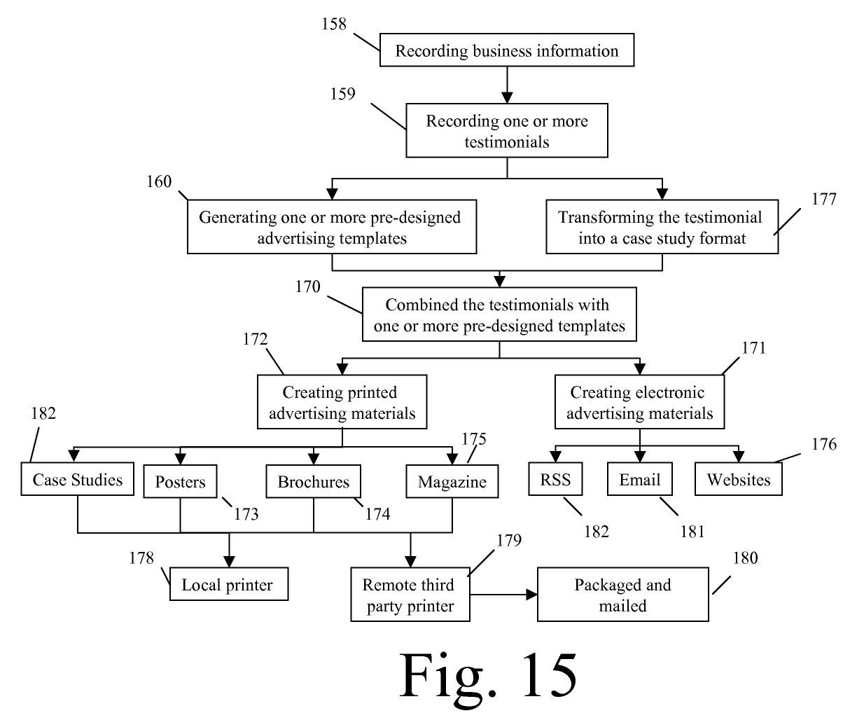

Finally, referring to FIG. 15, a flow chart illustrating the steps of the method of the present invention is provided. The method of advertising described by the present invention is enabled by a computer network multi-user network, and server. The method comprises the steps of first recording business information 158 and recording one or more testimonials 159 to a server located on a multi-user network. The server provides one or more pre-designed advertising templates 160 and combined the testimonials with one or more pre-designed templates 170 to create one or more electronic 171 advertising materials or printed advertising materials 172. The printed advertising materials 172 can be posters 173, brochures 174, magazine 175, websites 176, case studies 182, and other printable marketing materials. The electronic advertising materials 171 can be websites 176, email 181, RSS Feeds 182, the printed advertising materials 172 produced in an electronic format, and other electronic marketing methods. By accessing the server from a local computer over a multi-user network, a user may edit testimonial content; and edit pre-designed template content.

In an alternative embodiment, the testimonials 159 are replaced with case studies 177. The templates 170 displaying the testimonial 159 in a format called a case study 177 change the point of view to that of the testimonial 159 from the patient to that of the healthcare provider.

Multiple testimonials 159 may be combined on individual advertising materials 172. Multiple testimonials 172 may also populate website content on one or more websites. The printing of advertising materials 172 occurs on a local printer 178, or printing may occur on a remote third party printer 179 that is then packaged and mailed 180.

In an alternative embodiment testimonials are replaced with case studies. In many industries and locales it is not considered to be acceptable or legal to advertise with testimonials. A testimonial is a third party endorsement whereas a case study is a first party report of what occurred in any given situation or treatment. Thus, the method and system of the present invention may also utilize templates that display the material that might be included in a testimonial in a format called a case study and change the point of view to that from the patient to that of the healthcare provider. This would eliminate marketing restrictions imposed on testimonial advertising and would reduce or eliminate the need to reference individuals by name, which may be undesirable or increase liability exposure.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method of advertising, comprising the steps of:
recording business information;
recording one or more testimonials;
providing one or more pre-designed advertising templates;
combining the testimonial with one or more pre-designed templates to create one or more electronic or printed advertising materials; and
printing advertising materials.

2. The method of advertising of claim 1, wherein said advertising material is:
printed advertising materials consisting of posters, brochures, magazine, postcards, letters, mailers, and case studies; and
electronic advertising materials consisting of email, RSS feeds, websites, or electronic marketing.

3. The method of advertising of claim 1, wherein the testimonials are replaced with case studies.

4. The method of advertising of claim 1, wherein the templates displaying the testimonial in a format called a case study thereby changing the point of view to that of the testimonial from the patient to that of the healthcare provider.

5. The method of advertising of claim 1, wherein multiple testimonials are combined on individual advertising materials.

6. The method of advertising of claim 1, wherein multiple testimonials populate website content.

7. The method of advertising of claim 1, wherein testimonials or case studies are sent to a list, selected group, or individual user by email, fax, or printed letter.

8. The method of advertising of claim 1, further comprising the steps of
editing testimonial content; and
editing pre-designed template content.

9. The method of advertising of claim 1, wherein
printing occurs on a local printer, or
printing occurs on a remote third party printer and is packaged and mailed.

10. A system for providing generated advertising material to an end user, comprising
means for providing a graphical user interface to navigate a website, said website further comprising;
means for business management component;
means for user management component;
means for testimonial management component;
means for project management component;
means for template management component;
means for administrative management component;
means for providing a control panel for navigation and component selection; and
means for combining a testimonial with one ore more pre-designed templates to create one or more advertising materials; and
means for electronic delivery of advertising material; and
means for printing advertising material.

11. The system for providing generated advertising material to an end user of claim 10, wherein the business management component, further comprises
means for providing an existing user list;
said existing user list further comprising group name, business name, representative name information, business owner information, forms, information, and an action link;
means for uploading logos; and
means for providing graphical tools for editing said logos.

12. The system for providing generated advertising material to an end user of claim 10, wherein the clinic management component, further comprises
means for providing an all user list;
said all user list further comprising a username, full name, clinic name, and additional information;
means for tracking a user creation date, assigning a user class, recording activity and log information, and enabling user editing and removal; and
the control panel provides means to view all selections and add new users.

13. The system for providing generated advertising material to an end user of claim 10, wherein the user management component, further comprises
means for storing user information in a database; and
said database further comprising means for providing a detailed view and containing information uploaded by a user.

14. The system for providing generated advertising material to an end user of claim 10, wherein the template management component, further comprises
means for storing a template style list; and
said template style type comprising name, description and additional information for each template available to a user;
means for displaying all templates for use by a user; and
means for providing the ability of an administrator to add new templates, modify existing templates, or remove templates.

15. The system for providing generated advertising material to an end user of claim 10, wherein the testimonial management component, further comprises
means for storing testimonial details in a database;
said testimonial detail, as structured for health care providers, includes the patient name, city, account number, response to care, primary health care providers, referring health care providers, services performed, additional patient details, images of patient, and testimonial; and
means for storing addition details about the patient's condition in the database.

16. The system for providing generated advertising material to an end user of claim 10, wherein the testimonial management component, further comprises
means for storing and providing and image library that provides a database of images for use in templates;
means for searching and selecting images form the image library during an advertising generation process; and
mean for editing images in the image library.

17. The system for providing generated advertising material to an end user of claim 16, wherein said images include photographs of the person providing the testimonial.

18. The system for providing generated advertising material to an end user of claim 10, wherein the testimonial management component, further comprises
means for providing shop settings;
means for providing product forms;
said product form further comprising category, name, description, price, order, and photo information for each product;
means for creating specialized marketing materials; and
means providing a shopping component where each product is viewable and can be added to a shopping cart for processing.

19. The system for providing generated advertising material to an end user of claim 10, wherein the administration control component, further comprises
means for maintaining a list of referring healthcare providers;
means for maintaining a list of potential users;
means for selecting testimonials, healthcare providers, groups, or individual users based upon condition or interest;
means for reporting feedback, and
means for information gathering.

20. The system for providing generated advertising material to an end user of claim 18, wherein the testimonial management component provides
means for replacing the testimonials with case studies; and
means for displaying the testimonial in a format changing the point of view to that of the testimonial from a patient to that of the testimonial from a healthcare provider.
